(19) United States
(12) Patent Application Publication
(10) Pub. No.: US 2010/0284881 A1
(43) Pub. Date: Nov. 11, 2010

(54) DEPHOSPHORIZATION MATERIAL, DEPHOSPHORIZATION APPARATUS, AND DEPHOSPHORIZATION BY-PRODUCT

(75) Inventors: Yukio Yanagisawa, Tokyo (JP); Akihiro Yamasaki, Tsukuba-shi (JP); Atsushi Iizuka, Kashiwa-shi (JP); Goro Mohara, Matsudo-shi (JP)

Correspondence Address: MCDERMOTT WILL & EMERY LLP, 600 13TH STREET, N.W., WASHINGTON, DC, 20005-3096, US

(73) Assignee: NIPPON CONCRETE INDUSTRIES CO., LTD., Tokyo (JP)

(21) Appl. No.: 12/775,625

(22) Filed: May 7, 2010

(30) Foreign Application Priority Data
May 8, 2009 (JP) 2009-113860

(51) Int. Cl. C02F 1/58; C01B 15/16

(52) U.S. Cl. 423/307; 210/198.1; 210/205; 423/305

(57) ABSTRACT

A dephosphorization material is formed from concrete sludge resulting from centrifugal casting of concrete products, production of concrete, cleaning of concrete production equipment, or cleaning of concrete transporting vehicles. The dephosphorization material is used for dephosphorization treatment by a dephosphorization apparatus that includes a single reaction tank provided with a wastewater supply means, a dephosphorization material supply mean, and a recovery means. The dephosphorization apparatus removes phosphorus from phosphorus-containing wastewater, such as sewage water, based on the formula 10Ca²⁺+6PO₄³⁻+2OH⁻→Ca₁₀(PO₄)₆(OH)₂ and recovers through the recovery means a dephosphorization by-product that precipitates as crystals as a result of the reaction.

### INCORPORATION BY REFERENCE

The present application claims priority under 35 U.S.C. §119 to Japanese Patent Application No. 2009-113860 filed on May 8, 2009. The content of the application is incorporated herein by reference in its entirety.

### FIELD OF THE INVENTION

The present invention relates to a dephosphorization material for removing phosphorus from phosphorus-containing wastewater, such as sewage water, by using concrete sludge. The present invention further relates to a dephosphorization apparatus that utilizes the dephosphorization material to remove phosphorus from wastewater containing phosphorus, hereinafter phosphorus-containing wastewater. The present invention further relates to a dephosphorization by-product that can be recovered by the dephosphorization apparatus.

### BACKGROUND OF THE INVENTION

Due to such issues as water pollution resulting from eutrophication, and depletion of phosphorus resources, technologies for removing and recovering phosphorus from industrial wastewater or sewage water in which a relatively high concentration of phosphorus is dissolved are becoming increasingly important.

Examples of technologies for recovering phosphorus from such sewage water include the precipitation method and the coagulation method. The precipitation method is a method for causing phosphoric acid to precipitate in the form of crystals of MAP (magnesium ammonium phosphate) or HAP (hydroxyapatite) by adding magnesium salt or calcium salt to sewage water. The precipitation method has a number of advantages over the coagulation method, including not increasing sludge and higher purity of reaction products.

Known examples of a dephosphorization material used for the precipitation method described above in order to remove phosphorus from phosphorus-containing wastewater include one that is produced by granulating a composition consisting of a cement material, calcium hydroxide or calcium sulfate, and water; coating the surfaces of the resulting granules with a calcium compound; and subjecting the surfaces to carbonation treatment (Japanese Laid-open Patent Publication No. 2003-305479).

Another known example of a dephosphorization material is produced by mixing lightweight cellular concrete powder having a volume based average diameter of 5 μm to 0.3 mm, such a calcareous raw material as ordinary cement, and water; granulating the resulting mixture; and subjecting the resulting granules to autoclave curing (Japanese Laid-open Patent Publication No. 2008-100159).

Known examples of a dephosphorization apparatus used for dephosphorization by the precipitation method include one that has a dephosphorization column filled with a dephosphorization material, and a concrete waste material housing column filled with a concrete waste material (Japanese Laid-open Patent Publication No. 2001-47063). In the case of the dephosphorization apparatus disclosed in the above mentioned patent document, phosphorus-containing wastewater, such as sewage water, is circulated between the dephosphorization column and the concrete waste material housing column. As a result, phosphorus is removed from the phosphorus-containing wastewater in the dephosphorization column, and calcium phosphate is recovered. After the removal of the phosphorus, apart of the treated wastewater is fed into the concrete waste material housing column, where calcium ions are fed into the treated wastewater, and the pH of the treated wastewater is restored. Thereafter, the treated wastewater is again subjected to dephosphorization in the dephosphorization column.

A number of the applicants of the present invention were included in the authors of a document that provided a known example of a method of dephosphorization treatment, which includes steps of granulating a concrete waste material into cement waste fine powder with a particle diameter of approximately 1 mm, and using the cement waste fine powder as a dephosphorization material to remove phosphorus from phosphorus-containing wastewater (“Phosphorus Recovery from Wastewater Treatment Plant by Using Waste Concretes” by Goro Mohara and 5 others; KAGAKU KOGAKU RONBUNSHU, vol. 35, No. 1 pp. 12-19, 2009).

However, the dephosphorization materials respectively disclosed in Japanese Laid-open Patent Publication No. 2003-305479 and Japanese Laid-open Patent Publication No. 2008-100159 described above present a problem of complicated production processes, resulting in high production costs.

Dephosphorization treatment using a dephosphorization apparatus disclosed in Japanese Laid-open Patent Publication No. 2001-47063 described above presents a problem in that a dephosphorization column for dephosphorization of wastewater and a concrete waste material housing column for supply of calcium ions have to be provided separately, making the structure of the apparatus complicated. Furthermore, remnants resulting from production of construction materials are granulated into particles with a particle diameter of approximately 5 mm and used as the concrete waste material for filling the concrete waste material housing column. Normally, particles of concrete waste material with a particle diameter as large as 5 mm contain a large amount of fine aggregate particles with a particle diameter that is less than 5 mm. As these aggregate particles do not contribute to the reaction of dephosphorization of phosphorus-containing wastewater and also reduce the calcium content of the concrete waste material, the reaction rate of dephosphorization treatment is reduced, resulting in the possibility of greater difficulty in the removal of phosphorus from the phosphorus-containing wastewater.

According to the method of dephosphorization treatment described in the abovementioned KAGAKU KOGAKU RONBUNSHU, concrete waste has to be recovered from, for example, a demolition site so as to be used as the dephosphorization material. Furthermore, it is necessary to not only crush the recovered concrete waste but also classify the crushed concrete into particles with a diameter of not more than 1 mm. As a result, there is the possibility of increased treatment expenses.

In order to solve the above problems, the invention provides a dephosphorization material and a dephosphorization apparatus that facilitate, with an excellent reaction rate of dephosphorization treatment, removal of phosphorus from phosphorus-containing wastewater and are capable of holding down costs. Furthermore, the invention provides a dephosphorization by-product recovered through dephosphorization treatment using the abovementioned dephosphorization material or dephosphorization apparatus.

### SUMMARY OF THE INVENTION

A dephosphorization material according to a feature of the present invention is used for dephosphorization treatment for removing phosphorus from phosphorus-containing wastewater based on the formula 10Ca²⁺+6PO₄³⁻+20H⁻→Ca₁₀ (PO₄)₆ (OH)₂, and is formed from concrete sludge resulting from centrifugal casting of a concrete product, production of concrete, cleaning of concrete production equipment, or cleaning of a concrete transporting vehicle. Being formed from concrete sludge and therefore small in particle size, the dephosphorization material enables superior reaction rate for dephosphorization and facilitates removal of phosphorus from the phosphorus-containing wastewater. As concrete sludge is produced from centrifugal casting of a concrete product, production of concrete, cleaning of concrete production equipment, or cleaning of a concrete transporting vehicle and can be directly recovered from these processes, the dephosphorization material can be easily produced by merely adjusting the moisture content of the concrete sludge. Therefore, the present invention is effective in holding down production costs of the dephosphorization material.

A dephosphorization material according to another feature of the present invention is formed from sludge residue that remains after elution of calcium from concrete sludge. Forming the dephosphorization material from sludge residue that remains after elution of calcium from concrete sludge broadens the range of reuse of the concrete sludge. Furthermore, the dephosphorization material can be produced easily by merely eluting calcium from the concrete sludge and subsequently carrying out filtration.

A dephosphorization apparatus according to yet another feature of the present invention is used for dephosphorization treatment of phosphorus-containing wastewater by using the dephosphorization material according to the present invention and comprises a reaction tank; a wastewater supply means for feeding the phosphorus-containing wastewater into the reaction tank; a dephosphorization material supply means for feeding the dephosphorization material into the reaction tank; a stirring means for stirring the phosphorus-containing wastewater and the dephosphorization material in the reaction tank; and a recovery means for recovering a crystallized substance from the reaction tank. The dephosphorization apparatus is adapted to remove phosphorus from the phosphorus-containing wastewater by stirring the phosphorus-containing wastewater and the dephosphorization material in the reaction tank, thereby crystallizing calcium phosphate, and recover the crystallized dephosphorization by-product. Using the dephosphorization material described above enables superior reaction rate for dephosphorization, thereby facilitating recovery of the dephosphorization by-product. Furthermore, as the dephosphorization material supplies calcium ions and hydroxide ions and thereby enables dephosphorization treatment of phosphorus-containing wastewater in a single reaction tank, the dephosphorization apparatus can be formed with a simple structure, ultimately achieving lower treatment cost.

According to yet another feature of the present invention, the reaction tank of the dephosphorization apparatus is an open tank.

According to yet another feature of the present invention, the wastewater supply means and the dephosphorization material supply means of the dephosphorization apparatus are provided with valves for controlling supply of the phosphorus-containing wastewater and supply of the dephosphorization material, respectively.

According to yet another feature of the present invention, the stirring means of the dephosphorization apparatus is a stirring device equipped with stirring fins.

According to yet another feature of the present invention, the recovery means of the dephosphorization apparatus is a solid-liquid separator.

According to yet another feature of the present invention, the recovery means of the dephosphorization apparatus is a centrifugal separator.

A dephosphorization by-product according to yet another feature of the present invention is a dephosphorization by-product recovered by the dephosphorization apparatus and contains calcium phosphates with a weight ratio of not less than 15 wt %. As the weight ratio of the calcium phosphates in the dephosphorization by-product is not less than 15 wt %, it is possible to recover the dephosphorization by-product that is useful as a fertilizer.

### BRIEF DESCRIPTION OF THE DRAWINGS

FIG. 1 is a block diagram of a dephosphorization apparatus according to an embodiment of the present invention; FIG. 2(a) and FIG. 2(b) are SEM photographs showing surface conditions of a dephosphorization material sample of Comparative Example 1; FIG. 2(c) and FIG. 2(d) are SEM photographs showing surface conditions of a dephosphorization material sample for Working Example 1; FIG. 2(e) and FIG. 2(f) are SEM photographs showing surface conditions of a dephosphorization material sample for Working Example 2; FIG. 3 is a graph showing cumulative particle size distributions for Working Example 1, Working Example 2, and Comparative Example 1; FIG. 4 is a graph showing the relationship between reaction time and orthophosphoric acid concentration for Working Example 1, Working Example 2, and Comparative Example 1; FIG. 5 is a graph showing the relationship between reaction time and pH for Working Example 1, Working Example 2, and Comparative Example 1; FIG. 6 is a graph showing the relationship between reaction time and orthophosphoric acid concentration for Working Example 3, Working Example 4, and Working Example 6; FIG. 7 is a graph showing the relationship between reaction time and pH for Working Example 3, Working Example 4, and Working Example 6; FIG. 8 is a graph showing the relationship between reaction time and orthophosphoric acid concentration for Working Example 5 and Working Example 7; and FIG. 9 is a graph showing the relationship between reaction time and pH for Working Example 5 and Working Example 7.

### DETAILED DESCRIPTION OF THE PREFERRED EMBODIMENT

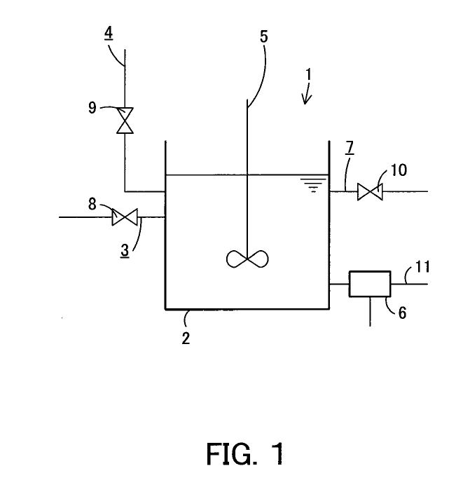

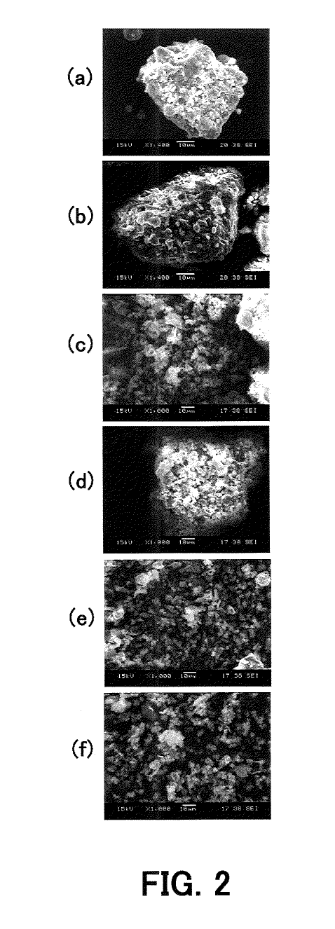

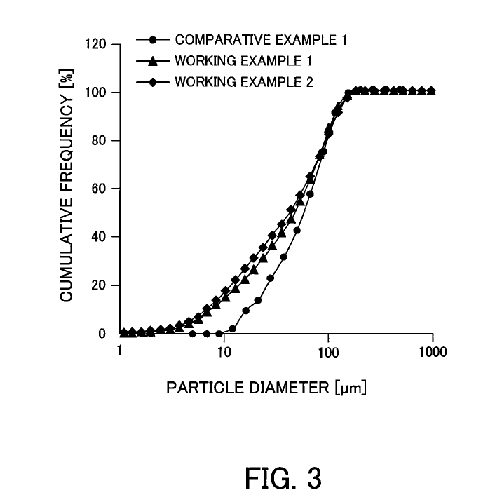

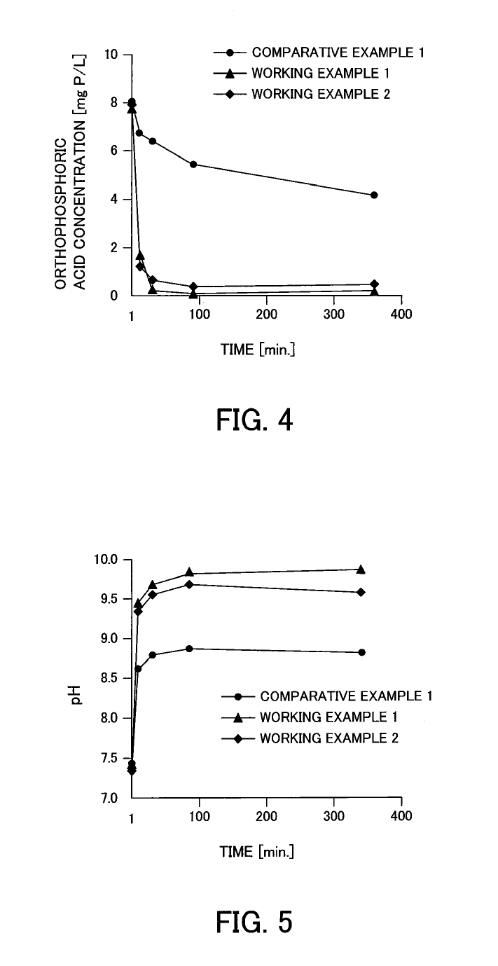

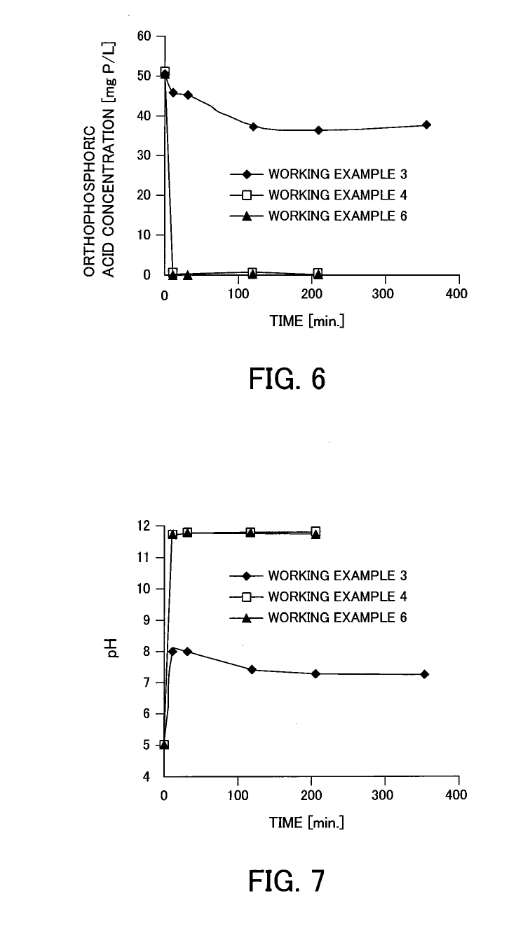

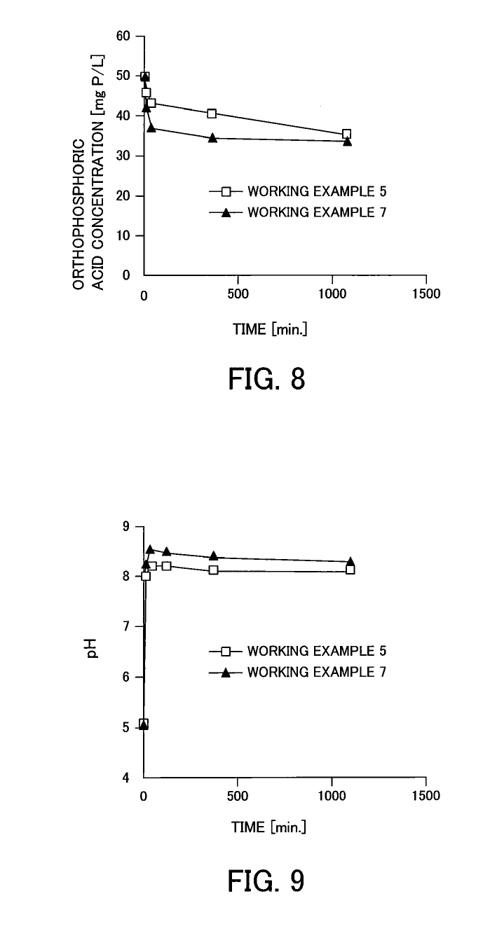

Next, an embodiment of the present invention is explained in detail hereunder, referring to FIG. 1.

A dephosphorization apparatus 1 shown in FIG. 1 serves to carry out dephosphorization treatment of phosphorus-containing wastewater by removing phosphorus from the phosphorus-containing wastewater by the precipitation method for crystallizing calcium phosphate by inducing reaction between the phosphorus-containing wastewater and a dephosphorization material. In other words, calcium phosphate is crystallized based on the formula 10Ca²⁺+6PO₄³⁻+2OH⁻→Ca₁₀(PO₄)₆ (OH)₂. As a result of this reaction, it is also possible to recover, as a dephosphorization by-product, calcium phosphate in the form of crystals of HAP (hydroxyapatite), which is useful as a fertilizer.

The dephosphorization apparatus 1 has an open reaction tank 2, which is provided with a wastewater supply means 3 and a dephosphorization material supply means 4. The wastewater supply means 3 serves to feed phosphorus-containing wastewater into the reaction tank 2. The dephosphorization material supply means 4 serves to feed the dephosphorization material into the reaction tank 2. The reaction tank 2 is also provided with a stirring means 5 for stirring the content of the reaction tank 2; a recovery means 6 for recovering the dephosphorization by-product, which is a crystallized substance in the reaction tank 2; and a treated water discharging means 7 for discharging from the reaction tank 2 the wastewater that has undergone dephosphorization treatment.

The wastewater supply means 3, the dephosphorization material supply means 4, and the treated water discharging means 7 are respectively provided with opening/closing means 8,9,10, such as valves. The opening/closing means 8 serves to control supply of the phosphorus-containing wastewater; the opening/closing means 9 serves to control supply of the dephosphorization material; and the opening/closing means 10 serves to control discharge of the treated water.

A means for ordinary stirring operation, such as a stirring device equipped with stirring fins, may be used as the stirring means 5.

A device that is capable of separating solid from liquid is used as the recovery means 6. Examples of such a device include a solid-liquid separator and a centrifugal separator. Furthermore, a discharge line 11 is connected to the recovery means 6 so that treated wastewater, from which the dephosphorization by-product has been removed, is discharged through the discharge line 11.

Examples of wastewater used as the phosphorus-containing wastewater include sewage water. Among the various types of sewage water, wastewater from an excess sludge dewatering process is particularly desirable. The wastewater from an excess sludge dewatering process is surplus water resulting from treatment of sewage water by an activated sludge method to produce sludge. As phosphorus is dissolved in the form of phosphoric acid with a high phosphorus concentration in the range of 10 to 200 mg P/L, the wastewater from an excess sludge dewatering process produces a good reaction efficiency when recovering phosphorus.

The dephosphorization material is formed from concrete sludge resulting from centrifugal casting of concrete products, production of concrete, cleaning of concrete production equipment, or cleaning of concrete transporting vehicles.

Cement hydrate compounds in concrete sludge contain a great amount of basic calcium compounds, such as calcium hydroxide, and, in an aqueous solution, induce dissolution reaction of calcium hydroxide, which is represented by the reaction formula Ca(OH)₂→Ca²⁺+2OH⁻, thereby functioning as calcium ions and hydroxide ions. The phosphorus in the phosphorus-containing wastewater precipitates primarily as HAP. Thus, phosphorus is removed from the phosphorus-containing wastewater.

Concrete sludge can be used as is as the dephosphorization material, or it is also possible to use screened pit sludge, which is a residual of the removal of aggregates from concrete sludge. It is also possible to use sludge residue that remains after elution of calcium from concrete sludge. This sludge residue is primarily comprised of silicon dioxide.

The dephosphorization material formed from such concrete sludge as described above has a particle diameter of not more than 0.1 mm, which is, for example, extremely finer than even cement waste fine powder with a particle diameter of 1 mm produced by finely crushing concrete waste as described in the aforementioned KAGAKU KOGAKU RONBUNSHU.

Furthermore, compared with ordinary concrete waste, such as cement waste fine powder described in the aforementioned KAGAKU KOGAKU RONBUNSHU, concrete sludge has a higher calcium content, which is necessary for generation of calcium phosphate.

With regard to the dephosphorization by-product, it is important to achieve an appropriate balance between phosphate ions, calcium ions, and hydroxide ions during crystallization of HAP. To be more specific, crystalline HAP grows on a seed material as a result of adjusting the amount of the calcium added and/or the pH so that the ion product, i.e. [Ca²⁺]₁₀[PO₄³⁻]₆[OH⁻]₂, in the solution is controlled within the range of 10⁻¹¹⁴ mol¹⁸l⁻¹⁸ to approximately 10⁻⁸⁰ mol¹⁸l⁻¹⁸, which are respectively the solubility product and the super-solubility product of HAP. Normally, precipitation is conducted with the pH in the range of 7 to 9. It is desirable that the weight ratio of calcium phosphates in the dephosphorization by-product produced as above be not less than 15 wt %, because such a dephosphorization material falls under the category of “by-product phosphate fertilizer” in the classification according to the Fertilizer Law.

Next, the function of the embodiment described above is explained hereunder.

Dephosphorization of phosphorus-containing wastewater by a dephosphorization apparatus 1 using a dephosphorization material formed from concrete sludge begins with feeding the phosphorus-containing wastewater into the reaction tank 2 through the wastewater supply means 3.

Next, the dephosphorization material is supplied by the dephosphorization material supply means 4, while the content in the reaction tank 2 is being stirred by the stirring means 5. As a result of supply of the dephosphorization material, calcium ions and hydroxide ions are fed to the phosphorus-containing wastewater in the reaction tank 2 so that reaction is induced in the reaction tank 2 between the phosphorus-containing wastewater and the dephosphorization material based on the reaction formula 10Ca²⁺+6PO₄³⁻+2OH⁻→Ca₁₀(PO₄)₆ (OH)₂. Furthermore, stirring the phosphorus-containing wastewater and the dephosphorization material in the reaction tank 2 by the stirring means 5 accelerates the reaction between the phosphorus-containing wastewater and the dephosphorization material. During this reaction, insoluble components, such as calcium silicate hydrate in the dephosphorization material, function as seed materials so that direct reaction occurs on the surface of the dephosphorization material between phosphate ions derived from the phosphorus-containing wastewater and calcium ions and hydroxide ions derived from the dephosphorization material and, as a result, induce precipitation of crystals of HAP, which is a calcium phosphate.

Thereafter, precipitated HAP crystals are separated and recovered as a dephosphorization by-product by solid-liquid separation by the recovery means 6.

The wastewater that has undergone the dephosphorization treatment is discharged through the treated wastewater discharging means 7, and the treated water separated by the solid-liquid separation by the recovery means 6 is discharged through the discharge line 11.

As the dephosphorization material formed from concrete sludge has solid components that react with phosphorus-containing wastewater are particles of extremely small size, i.e. not more than 0.1 mm, the dephosphorization material enables superior reaction rate compared with, for example, the dephosphorization material produced by finely crushing concrete waste as described in the aforementioned KAGAKU KOGAKU RONBUNSHU. Furthermore, as concrete sludge contains a large amount of calcium components derived from cement, concrete sludge reacts easily with phosphorus-containing wastewater, resulting in satisfactory dephosphorization.

Furthermore, concrete sludge results from centrifugal casting of concrete products, production of concrete, cleaning of concrete production equipment, or cleaning of concrete transporting vehicles. Therefore, concrete sludge can be easily recovered without the need for a special facility or equipment and also enables production of the dephosphorization material as a part of such a process as a production process of concrete or a concrete product, or a cleaning process of concrete production equipment or concrete transporting vehicles. In cases where concrete sludge is used as is for producing the dephosphorization material, the dephosphorization material can be produced easily by merely adjusting the moisture content of the concrete. In cases where concrete sludge residue is used, the dephosphorization material can be produced easily by merely eluting calcium from the concrete sludge and carrying out solid-liquid separation. Therefore, it is possible to hold down production costs of the dephosphorization material.

As concrete sludge has a high calcium content and exhibits a high alkaline characteristic, it is normally disposed of after being subjected to neutralization treatment by adding diluted sulfuric acid, and therefore necessitates neutralization equipment and diluted sulfuric acid for disposal thereof. Production of a dephosphorization material from concrete sludge enables recycling of concrete sludge so that the concrete sludge that would otherwise have been disposed of is recycled as a useful resource, and also enables reduction of costs that accrue for disposal of concrete sludge after production of concrete products or concrete. Furthermore, the use of concrete sludge is also economical in that almost no costs for material are required, because concrete sludge is conventionally a waste material to be disposed of.

Furthermore, forming the dephosphorization material by using sludge residue that remains after elution of calcium from concrete sludge enables efficient use of the concrete sludge and broadens the range of reuse of the concrete sludge.

As a dephosphorization material formed from concrete sludge is used for dephosphorization treatment, various effects are obtained, including a pH increasing effect resulting from supply of an alkali, an effect enabling the simultaneous supply of calcium ions and hydroxide ions, a seed material effect of insoluble components, such as calcium silicate hydrate, and a direct reaction effect between calcium ions and phosphate ions; in other words, a direct reaction occurring on the surface of the dephosphorization material between calcium ions derived from the dephosphorization material and phosphate ions derived from the phosphorus-containing wastewater. These effects facilitate crystallization of calcium phosphate from phosphorus-containing wastewater. By merely feeding the dephosphorization material to the phosphorus-containing wastewater and stirring the phosphorus-containing wastewater and the dephosphorization material in the reaction tank 2, the insoluble components of the dephosphorization material function as a seed material to cause direct reaction between the calcium components and phosphates on the surface of the dephosphorization material, resulting in precipitation of crystals of calcium phosphate and consequently making possible the removal of phosphorus. In other words, dephosphorization can be performed by using a single reaction tank 2. As dephosphorization can thus be performed by using a single reaction tank 2, the dephosphorization apparatus 1 can be formed with a simple structure. Therefore, as the dephosphorization apparatus can be produced easily, it is possible to hold down costs for treatment of phosphorus-containing wastewater. Furthermore, as superior reaction rate of the dephosphorization material makes it possible to reduce the size of the treatment equipment as well as the length of the treatment time, the present invention is economical.

Having a higher calcium content than that of ordinary concrete waste, concrete sludge facilitates the increase of the weight ratio of calcium phosphates in the crystallized HAP, which is the dephosphorization by-product.

Making the weight ratio of the calcium phosphates in the dephosphorization by-product 15 wt % or greater enables recovery of the calcium phosphates that are useful as a fertilizer classified in the category of the “by-product phosphate fertilizer” according to the Fertilizer Law. Furthermore, after recovery thereof, the calcium phosphates can be used as a fertilizer without special treatment.

Next, working examples of the invention are explained hereunder.

A dephosphorization test was performed to ascertain the respective dephosphorization abilities of various dephosphorization material samples by using wastewater from a belt press excess sludge dewatering process as a model aqueous solution of sewage water, which is a phosphorus-containing wastewater. The wastewater used for this test had an orthophosphoric acid concentration of 7.89 mg P/L and pH of 7.2.

Used for the dephosphorization material samples for the test was sludge residue resulting from a twenty-fold dilution of centrifugal sludge taken from a screen pit and repeating calcium extraction. To be more specific, after carrying out calcium extraction two times (corresponding to a calcium extraction rate of 13%), the resulting sludge residue was dried and used as a dephosphorization material sample for Working Example 1. After carrying out calcium extraction eight times (corresponding to a calcium extraction rate of 36%), the resulting sludge residue was dried and used as a dephosphorization material sample for Working Example 2. As Comparative Example 1 for comparing the respective dephosphorization abilities of the dephosphorization material samples, a dephosphorization test was performed in the same manner as above, using a dephosphorization material sample formed from waste cement fine powder. Waste from a coarse aggregate recycling plant using a mechanical grinding method was used as a dephosphorization material sample for Comparative Example 1. The chemical compositions of the dephosphorization material samples for Working Example 1, Working Example 2, and Comparative Example 1 are shown in Table 1.

TABLE 1
Chemical Compositions of Sludge Residue Samples and Waste
Cement Fine Powder (wt %)

| | Comparative | Sludge Residue | | |
|---|---|---|---|---|
| | Example 1 | Working Example 1 | Working Example 2 | Reference |
| | Waste cement | Extracted twice | Extracted 8 times | Untreated |
| | fine powder | (13% extraction) | (36% extraction) | sludge (0%) |
| Calcium | 27.3 | 32 | 25 | 35 |
| Silicon | 6.3 | 4.4 | 4.8 | 4.2 |
| Aluminum | 1.1 | 1.0 | 1.1 | 1.0 |
| Iron | 4.3 | 3.8 | 4.1 | 3.6 |
| Magnesium | 0.1 | 0.2 | 0.2 | 0.2 |
| Sulfur | 0.5 | 1.2 | 1.3 | 1.2 |
| Potassium | 0.2 | 0.2 | 0.2 | 0.1 |
| Phosphorus | — | 0.1 | 0.1 | 0.1 |
| Manganese | 0.2 | 0.1 | 0.1 | 0.1 |
| Zinc | 0.1 | 0.1 | 0.1 | 0.1 |
| Lead | — | 0.01 | 0.01 | 0.01 |
| Subtotal | 40.2 | 42.7 | 37.5 | 45.3 |
| Other | 59.8 | 57.3 | 62.5 | 54.7 |
| Total | 100 | 100 | 100 | 100 |

Untreated sludge referred to as “Reference” in Table 1 is a dried solid of concrete sludge that did not undergo calcium extraction. Whereas the calcium content of the dephosphorization material sample for Comparative Example 1 was 27.3%, that of the untreated sludge was 35%. Therefore, it is evident that concrete sludge has a higher calcium content than that of the waste cement fine powder.

As shown in FIG. 2(a) to FIG. 2(f), which depict surface conditions of the dephosphorization material samples for Working Example 1, Working Example 2, and Comparative Example 1, it is evident that the surface of the dephosphorization material samples for Working Example 1 and Working Example 2 is more bumpy than that of the dephosphorization material sample for Comparative Example 1.

FIG. 3 shows the cumulative particle size distributions of the sludge residue for Working Example 1 and Working Example 2, as well as the cumulative particle size distribution of the cement waste fine powder for Comparative Example 1. As shown in FIG. 3, the medians of the particles diameters for Working Example 1, Working Example 2, and Comparative Example 1 were approximately 50 μm, 44 μm, and 60 μm, respectively. Therefore, it is evident that the samples for Working Example 1 and Working Example 2 had smaller particles compared with that for Comparative Example 1.

The surface area of the sludge residue for Working Example 2 was 29 m²/g, whereas that of the cement waste fine powder for Comparative Example 1 was 6.15 m²/g. For reference, the surface area of the dried solid of untreated sludge was 2.61 m²/g. Furthermore, the dephosphorization ability of such untreated sludge was ascertained in Working Examples 3 to 7, which will be explained later.

The dephosphorization test was performed by, first of all, 300 ml of the model aqueous solution was fed into each one of plastic beakers for Working Example 1, Working Example 2, and Comparative Example 1, and the solution in each beaker was stirred by a stirrer at 300 rpm.

Then, while the model aqueous solution was being stirred, the dephosphorization material samples for Working Example 1, Working Example 2, and Comparative Example 1 are respectively introduced into the beakers containing the model solution. The amount of each dephosphorization material sample introduced into each respective beaker was such that the weight ratio of the calcium in the dephosphorization material sample to the phosphorus in the model aqueous solution was 5:1. After the addition of the dephosphorization material sample, changes in the orthophosphoric acid concentration and pH in the model aqueous solution in each beaker was monitored. Measurement of orthophosphoric acid concentration was performed by the molybdenum blue method, while pH was measured by using a pH meter.

As shown in FIG. 4, after introducing the respective dephosphorization material samples, all of Working Example 1, Working Example 2, and Comparative Example 1 exhibited a decrease of the orthophosphoric acid concentration in the model aqueous solution.

It is surmised that the decrease of the orthophosphoric acid concentration resulted from the calcium ions and the hydroxide ions in each dephosphorization material sample inducing precipitation of the phosphorus as HAP in the model aqueous solution.

After introducing the dephosphorization material samples, Working Example 1 and Working Example 2, in particular, exhibited a substantial decrease of the orthophosphoric acid concentration in the model aqueous solution, resulting in removal of more than 80% of the phosphorus from the wastewater in 10 minutes. In other words, regardless of the conditions of the weight ratio between calcium and phosphorus being the same, the dephosphorization material samples for Working Example 1 and Working Example 2 exhibited a greater dephosphorization ability than that of the dephosphorization material sample for Comparative Example 1. This result indicates excellent dephosphorization ability of the dephosphorization material samples for Working Example 1 and Working Example 2, because the proportion of the calcium that was contained in the dephosphorization material sample and reacted with phosphorus for Working Example 1 or Working Example 2 was greater than the proportion of the calcium that was contained in the dephosphorization material sample and reacted with phosphorus for Comparative Example 1.

This seems to result from the particle diameter and the surface area of each dephosphorization material sample. In other words, the sludge residue for Working Example 1 and the sludge residue used as the dephosphorization material sample for Working Example 2 had a smaller particle diameter and a larger surface area, compared with waste cement fine powder, which served as the dephosphorization material sample for Comparative Example 1. It can be surmised that this resulted in their excellent reaction rate and the substantial decrease of the phosphorus concentration.

As shown in FIG. 5, after introducing the respective dephosphorization material samples, Working Example 1, Working Example 2, and Comparative Example 1 all exhibited an increase of pH of the wastewater filtered by belt press. The degree of increase of the pH was greater after introducing the sludge residue for Working Example 1 or the dephosphorization material sample for Working Example 2 than after introducing the dephosphorization material sample for Comparative Example 1. It can be surmised from this result that the sludge residue for Working Example 1 and the sludge residue used as the dephosphorization material sample for Working Example 2 demonstrated greater ability for supplying alkaline; in other words, greater ability for promoting generation of calcium phosphate, compared with waste cement fine powder, which served as the dephosphorization material sample for Comparative Example 1.

Next, dephosphorization ability resulting from different conditions of concrete sludge was ascertained.

Casting sludge resulting from centrifugal formation of a concrete pole was temporarily retained.

Together with water used for washing, the casting sludge was conveyed through a pipeline to a sludge treatment facility, where aggregate was removed from the sludge by using a screen. The resulting sludge, in other words screened pit sludge, was temporarily retained.

The screened pit sludge was then dewatered by using a filter press to separate the sludge into solid components and filtered water, in other words, water that was treated by filter press. Then, the filtered water was temporarily retained. After solid-liquid separation, the solid is usually handed over as industrial waste to disposal contractors, and the water treated by filter press is neutralized with sulfuric acid and subsequently discharged to the outside of the facility.

The collected casting sludge and screened pit sludge were diluted ten-fold by weight ratio with ion-exchange water. The diluted sludge was then stored at room temperature while being subjected to agitation at appropriate times, and, thereafter, was used as dephosphorization material samples. After being collected, the water treated by filter press was stored at room temperature without being subjected to dilution or other treatment, and ultimately used as dephosphorization material samples.

The filtered water that had been stored for 21 hours after collection was used as the dephosphorization material sample for Working Example 3. The screened pit sludge that had been stored for 21 hours after collection was used as the dephosphorization material sample for Working Example 4. The screened pit sludge that had been stored for 27 hours after collection was used as the dephosphorization material sample for Working Example 5. The casting sludge that had been stored for 21 hours after collection was used as the dephosphorization material sample for Working Example 6. The casting sludge that had been stored for 27 hours after collection was used as the dephosphorization material sample for Working Example 7.

An aqueous solution of potassium dihydrogen phosphate with a concentration of 50 mg P/L was used as the model aqueous solution of phosphorus-containing wastewater. In the same manner as Working Example 1, Working Example 2, and Comparative Example 1 described above, each respective dephosphorization material sample for each one of Working Examples 3 to 7 was introduced into each plastic beaker containing the model aqueous solution, which was being stirred by a stirrer at 300 rpm. The test conditions for Working Examples 3 to 7 are shown in Table 2. In the test where the amount of the dephosphorization material sample was 10 g, each plastic beaker containing the model aqueous solution was agitated. Thereafter, 10 g of each dephosphorization material sample was measured into a weighing bottle and subsequently introduced into the beaker. In the test where the amount of the dephosphorization material sample was 1 ml, each plastic beaker containing the model aqueous solution was agitated, and, thereafter, 1 ml each of the dephosphorization material samples was added to each respective beaker.

TABLE 2

| | Working Example 3 | Working Example 4 | Working Example 5 | Working Example 6 | Working Example 7 |
|---|---|---|---|---|---|
| | Water treated | Screened pit sludge | Screened pit sludge | Casting sludge | Casting sludge |
| | by filter press | 10-fold dilution | 10-fold dilution | 10-fold dilution | 10-fold dilution |
| Volume of model | 300 | 300 | 300 | 300 | 300 |
| aqueous solution | | | | | |
| [ml] | | | | | |
| Initial | 50 | 50 | 50 | 50 | 50 |
| concentration of | | | | | |
| phosphate ions [mg | | | | | |
| P/L⁻¹] | | | | | |
| Amount of sludge | 10 g | 10 g | 1 ml | 10 g | 1 ml |

After the model aqueous solution in each beaker into which each respective dephosphorization material sample for Working Example 3 to 7 had been introduced was stirred for a specified period of time, the content of each beaker was sampled to measure the orthophosphoric acid concentration and pH thereof by the molybdenum blue method and a pH meter, respectively.

FIG. 6 shows changes in the orthophosphoric acid concentration in the model aqueous solution. In Working Example 3, the orthophosphoric acid concentration gradually decreased and eventually reached 37 mg P/L. In Working Example 4 and Working Example 6, the orthophosphoric acid concentration rapidly decreased, reaching nearly zero within ten minutes.

FIG. 7 shows changes in pH of the model aqueous solution. In Working Example 3, the pH increased to 8 within approximately 10 minutes of the start of reaction and, thereafter, came into the range of 7 to 8. In Working Example 4 and Working Example 6, the pH increased to nearly 12 within approximately 10 minutes of the start of reaction, indicating that the respective dephosphorization materials for Working Example 4 and Working Example 6 had a high alkali content.

FIG. 8 shows changes in the orthophosphoric acid concentration in the model aqueous solution. In both Working Examples 5 and 7, the orthophosphoric acid concentration decreased to nearly 35 mg P/L within 1,080 minutes of the start of reaction. Working Example 7 exhibited a slightly greater decrease in the orthophosphoric acid concentration than did Working Example 5, possibly the result of a difference in the original calcium content of each Working Example.

FIG. 9 shows changes in pH of the model aqueous solution. In both Working Example 5 and Working Example 7, the pH rapidly increased into the range of 8 to 9 within approximately 10 minutes of the start of reaction. It is evident from this result that the dephosphorization material samples for both Working Examples contained a large amount of alkalis in the liquid phase thereof.

What is claimed is:

1. A dephosphorization material used for dephosphorization treatment for removing phosphorus from phosphorus-containing wastewater based on the formula 10Ca²⁺+6PO₄³⁻+2OH⁻→Ca₁₀(PO₄)₆(OH)₂,
the dephosphorization material being formed from concrete sludge resulting from centrifugal casting of a concrete product, production of concrete, cleaning of concrete production equipment, or cleaning of a concrete transporting vehicle.

2. A dephosphorization material as claimed in claim 1, wherein:
the dephosphorization material is formed from sludge residue that remains after elution of calcium from concrete sludge.

3. A dephosphorization apparatus for dephosphorization treatment of phosphorus-containing wastewater by using the dephosphorization material as claimed in claim 1, the dephosphorization apparatus comprising:
a reaction tank;
a wastewater supply means for feeding the phosphorus-containing wastewater into the reaction tank;
a dephosphorization material supply means for feeding the dephosphorization material into the reaction tank;
a stirring means for stirring the phosphorus-containing wastewater and the dephosphorization material in the reaction tank; and
a recovery means for recovering a crystallized substance from the reaction tank;
the dephosphorization apparatus being adapted to remove phosphorus from the phosphorus-containing wastewater by stirring the phosphorus-containing wastewater and the dephosphorization material in the reaction tank, thereby crystallizing calcium phosphate, and recover the crystallized calcium phosphate, which is a dephosphorization by-product.

4. A dephosphorization apparatus as claimed in claim 3, wherein:
the reaction tank is an open tank.

5. A dephosphorization apparatus as claimed in claim 3, wherein:
the wastewater supply means is provided with a valve for controlling supply of the phosphorus-containing wastewater; and
the dephosphorization material supply means is provided with a valve for controlling supply of the dephosphorization material.

6. A dephosphorization apparatus as claimed in claim 3, wherein:
the stirring means is a stirring device equipped with stirring fins.

7. A dephosphorization apparatus as claimed in claim 3, wherein:
the recovery means is a solid-liquid separator.

8. A dephosphorization apparatus as claimed in claim 3, wherein:
the recovery means is a centrifugal separator.

9. A dephosphorization by-product recovered by the dephosphorization apparatus as claimed in claim 3, wherein:
the dephosphorization by-product contains calcium phosphates with a weight ratio of not less than 15 wt %.
